(19) United States
(12) Patent Application Publication
(10) Pub. No.: US 2017/0235658 A1
(43) Pub. Date: Aug. 17, 2017

(54) ANALYSIS DEVICE AND ANALYSIS METHOD

(71) Applicant: Renesas Electronics Corporation, Tokyo (JP)

(72) Inventor: Hisashi HATA, Tokyo (JP)

(21) Appl. No.: 15/502,963

(22) PCT Filed: Mar. 27, 2015
(86) PCT No.: PCT/JP2015/059630

§ 371 Date: Feb. 9, 2017

(51) Int. Cl. G06F 11/34; G06F 11/00; G06F 11/30

(52) U.S. Cl. CPC G06F 11/3447; G06F 11/3006; G06F 11/004; G06F 2201/86

(57) ABSTRACT

An analysis device for analyzing an operation of a target system has a behavior model obtained by modeling the operation of the target system, a log in which an event occurring when the target system is operated is recorded in time series is inputted to the analysis device, and the analysis device searches for an event string according to occurrence order obtained by statically analyzing the behavior model, from a plurality of events recorded in the log in time series. In the case where the target system includes a plurality of subsystems, the behavior model includes a plurality of behavior scenarios representing respective behaviors of the subsystems and a configuration model representing connection relation between the subsystems, and in each behavior scenario, a task executed by a corresponding subsystem and an event generated by the task are described.

### TECHNICAL FIELD

The present invention relates to an analysis device and an analysis method, and is particularly suited to an analysis device and an analysis method for supporting the operation analysis of a system comprised of a plurality of subsystems.

### BACKGROUND ART

Distributed embedded systems are becoming large-scaled and complicated. However, the evaluation of such a system depends largely on manpower, such as the visual check of a protocol analyzer, and support man-hours and man-hours such as error location identification and performance evaluation are increasing.

Patent Literature 1 discloses an event log analysis support device that can easily set the search criteria of an event log and displays the event log in association with the search criteria. Message logs (character strings) outputted from a plurality of servers are filtered by regular expression. A plurality of regular expressions can be set, and the filtering result is graphically displayed in time series.

Patent Literature 2 discloses a technique for facilitating the analysis of software in the whole of a system in which a plurality of control modules are dispersedly mounted. Timers for counting times common to the whole system are installed into the respective control modules, and the control modules output event logs to which time stamps using the times of the respective timers are added.

### PRIOR ART LITERATURE

### Patent Literature

[Patent Literature 1] Japanese Unexamined Patent Publication No. 2005-141663
[Patent Literature 2] Japanese Unexamined Patent Publication No. 2015-035158

### DISCLOSURE OF THE INVENTION

### Problems that the Invention is to Solve

The present inventors have examined Patent Literatures 1 and 2, and found the following new problems.

The event log analysis support device disclosed in Patent Literature 1 can perform only filtering by regular expression character string matching. Therefore, it is difficult to perform setting for specifying the occurrence order of events such as that “an event B occurs after an event A occurs”. Consequently, for the evaluation of the event log, a person visually confirms the result of filtering. In the event log analysis support device disclosed in Patent Literature 1, to automate the evaluation of the event log, an expected value is required in order to grasp an operation situation by comparing the expected value and the log. The comparison with the expected value is effective in a verification stage, but difficult to apply to a use such as the identification of a cause location at the occurrence of an error.

The system disclosed in Patent Literature 2 is effective at accurately evaluating the event logs of the whole system because it is possible to accurately grasp the generated time series (before-after relation) of events individually occurring in the dispersed control systems; however, a person performs visual confirmation in this case as well.

From now on, as the system becomes larger-scaled and more complicated, visual confirmation by manpower becomes more difficult.

Means for solving these problems will be described below, and the other problems and novel features will become apparent from the description of this specification and the accompanying drawings.

### Means for Solving the Problems

One embodiment is as follows.

That is, an analysis device for analyzing an operation of a target system has a behavior model obtained by modeling the operation of the target system, a log in which an event occurring when the target system is operated is recorded in time series is inputted to the analysis device, and the analysis device searches for an event string according to occurrence order obtained by statically analyzing the behavior model, from a plurality of events recorded in the log in time series.

### Effects of the Invention

An effect obtained by the one embodiment will be briefly described as follows.

That is, even if the target system is large-scaled and complicated, it is possible to suppress man-hours required for analysis and debugging.

### BRIEF DESCRIPTION OF THE DRAWINGS

FIG. 1 is a block diagram showing a configuration example of an evaluation system including an analysis device 110 according to a first embodiment.

FIG. 2 is an explanation diagram showing a configuration example of a target system.

FIG. 3 is an explanation diagram showing a configuration example of a behavior model.

FIG. 4 is an explanation diagram showing the flow of the whole analysis.

FIG. 5 is an explanation diagram showing an example of a log outputted from a subsystem A(Sys_A).

FIG. 6 is an explanation diagram showing an example of a log outputted from a subsystem B(Sys_B).

FIG. 7 is an explanation diagram showing an example of a system log of the whole target system obtained by integrating the logs outputted from the subsystems A and B (Sys_A and Sys_B).

FIG. 8 is an explanation diagram schematically showing the integrated system log.

FIG. 9 is an explanation diagram showing an example of the association of tasks of behavior scenarios in the behavior model.

FIG. 10 is an explanation diagram showing an example of source code describing a structure model.

FIG. 11 is an explanation diagram showing an example of source code describing an interface declaration.

FIG. 12 is an explanation diagram showing an example of source code describing the behavior scenario of the subsystem A(Sys_A).

FIG. 13 is an explanation diagram showing an example of source code describing the behavior scenario of the subsystem B(Sys_B).

FIG. 14 is an explanation diagram showing an example of source code describing the behavior scenario of a router (Router).

FIG. 15 is a flowchart showing an example of a flow for searching the system log.

FIG. 16 is an explanation diagram schematically showing an example of an operation for searching the system log.

FIG. 17 is an explanation diagram schematically showing an example of a structure model including the behavior scenario of a router (Router).

FIG. 18 is an explanation diagram schematically showing an example of a system log in the case of estimating an operation.

FIG. 19 is an explanation diagram schematically showing an example of a hierarchically configured behavior model.

FIG. 20 is a schematic block diagram showing a configuration example of a target system in which a plurality of control units are connected to an in-vehicle network.

### BEST MODE FOR CARRYING OUT THE INVENTION

Hereinafter, embodiments will be described in detail. In all the drawings for illustrating modes for carrying out the invention, elements having the same functions are denoted by the same reference numerals, and their description will not be repeated.

### First Embodiment

An analysis device, for analyzing an operation of a target system, according to a first embodiment has a behavior model obtained by modeling the operation of the target system, a log in which an event occurring when the target system is operated is recorded in time series is inputted to the analysis device, and the analysis device searches for an event string according to occurrence order obtained by statically analyzing the behavior model, from a plurality of events recorded in the log in time series.

An analysis method according to the first embodiment is an analysis method for analyzing an operation of a target system, using a computer, and has a behavior model stored in a storage device of the computer and an analysis program for performing an analysis operation by being executed by the computer. The behavior model is obtained by modeling the operation of the target system. The analysis operation by the analysis program extracts an event string according to expected occurrence order by statically analyzing the behavior model. Further, a log in which an event occurring when the target system is operated is recorded in time series is inputted, and the analysis operation searches for whether the extracted event string exists in the log.

In this context, the target system refers to a system of an analysis target, and may be hardware, software, or a system in which hardware and software operate in cooperation with each other. Further, the term “analysis” in this application is not limited to “analysis” for pursuing the cause of an abnormal operation (behavior), such as debugging in a development process and failure analysis, but includes “verification” for alternatively determining whether or not to match a normal operation (behavior).

Thereby, even if the target system is large-scaled and complicated, it is possible to suppress man-hours required for analysis and debugging. In the log (system log) in which the event occurring when the target system is operated is recorded in time series, the occurrence order of the actually occurring event is recorded. However, there is not included information for distinguishing whether this occurrence order is generated based on a defined causal relation such as the result of transmission/reception of a message or a parameter, performed between tasks generating events or based on a mere coincidence. The analysis device and method according to the first embodiment extract an event string according to expected occurrence order, and search for a match from a plurality of events recorded in the system log. If the matched event string is found, there is obtained a certain analysis result such as that it is expected that a series of tasks generating the event string are executed normally, and it is possible to proceed to the analysis of the remaining event strings. Therefore, even if the target system is large-scaled and complicated, and accordingly, an enormous number of events are recorded in the system log, it is possible to suppress man-hours required for analysis and debugging.

This is particularly effective for the target system that is comprised of a plurality of subsystems. In this case, the behavior model includes a plurality of behavior scenarios representing respective behaviors of the subsystems and a configuration model representing connection relation between the subsystems, and in each behavior scenario, a task executed by a corresponding subsystem and an event generated by the task are described. An event generated from each subsystem when the target system is operated and a time stamp indicating an occurrence time of the event by a time common to the whole target system are recorded in a system log. The analysis device or the analysis method extracts, from the behavior model, a plurality of tasks executed sequentially with a predetermined start task as a starting point and a string of a plurality of events sequentially occurring accordingly, and collates the string of the events with a plurality of events arranged in occurrence order based on the time stamp recorded in the system log.

If the target system becomes large-scaled and complicated by having a subsystem added thereto, a behavior scenario corresponding to the added subsystem is added to the behavior model, and the connection relation between the added subsystem and another subsystem is added to the configuration model, thereby enabling the addition of the subsystem.

The foregoing is a basic technical idea that is not limited to first to fourth embodiments detailed below but also can be applied to other embodiments with various changes and modifications.

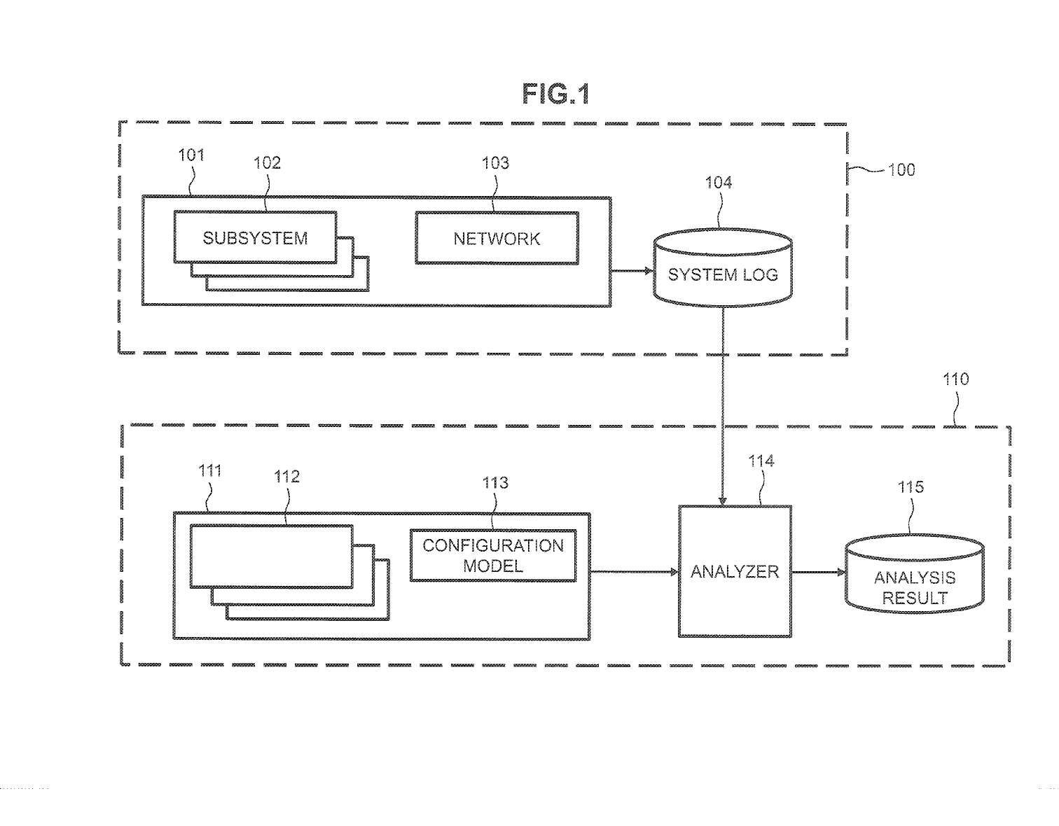

FIG. 1 is a block diagram showing a configuration example of an evaluation system including an analysis device 110 according to the first embodiment. The evaluation system is comprised of a dynamic evaluation device 100 and the analysis device 110. The dynamic evaluation device 100 operates a target system 101 and acquires a system log 104. The target system 101 is defined, for example, as a distributed embedded system in which a plurality of subsystems 102 are connected through a network 103.

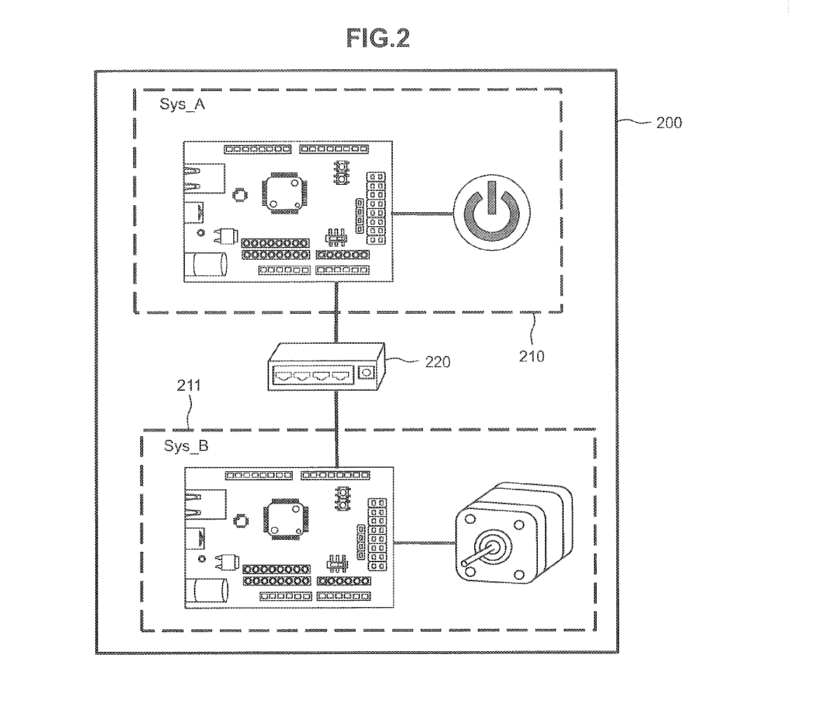

FIG. 2 shows a target system 200 as a configuration example of the target system 101. The target system 200 is defined as the integrated whole of an embedded system in which two subsystems Sys_A(210) and Sys_B(211) are connected by a network 220. The subsystems are comprised of devices (microcomputer, motor, etc.), software, and the like, and each subsystem provides an application (function). Since the subsystem is defined as the application, a plurality of subsystems may be included in one hardware. The target system implements one integrated application by combining the subsystems.

Referring back to FIG. 1, the analysis device 110 is comprised of a behavior model 111 and an analyzer 114. The behavior model 111 is data obtained by modeling the operation of the target system 101, and is comprised of behavior scenarios 112 representing the operations of the subsystems 102 and a configuration model 113 representing configuration information between the subsystems. The behavior model 111 and the system log 104 are inputted to the analyzer 114, and the analyzer 114 outputs an analysis result 115. The analysis device 110 can be implemented, for example, by operating an analysis program on a computer including a processor and a storage device. In this case, the behavior scenarios 112, the configuration model 113, and the whole behavior model 111 are source code described in accordance with predetermined grammar or data obtained by encoding the source code, and are stored in the storage device of the computer. Also, the system log 104 is inputted as predetermined-format electronic data such as text data. The analyzer 114 executes the analysis program, so that the function is implemented. The above-described method of implementing the analysis device 110 is merely an example, and the analysis device 110 can be implemented in various forms without departing from the scope.

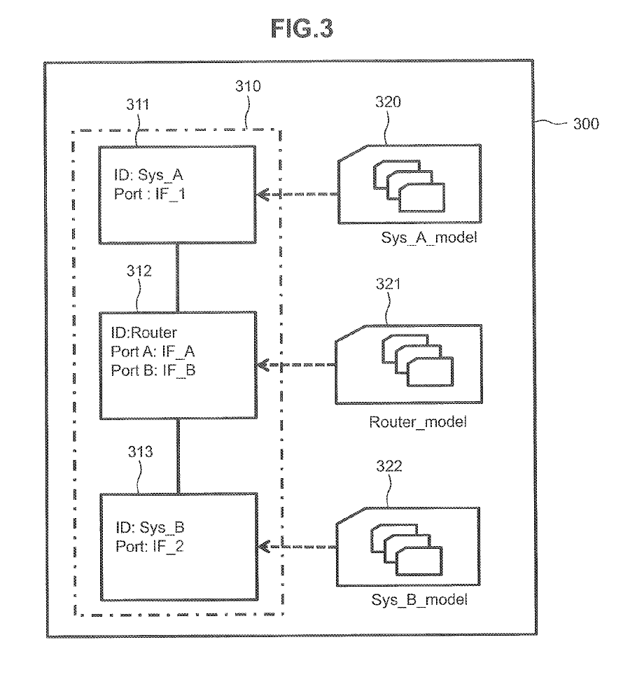

FIG. 3 illustrates a behavior model 300 constructed corresponding to the target system 200 illustrated in FIG. 2. The behavior model 300 is comprised of a configuration model 310 and behavior scenarios 320, 321, 322. Instances 311, 312, 313 of the configuration model correspond to the subsystem Sys_A(210), the network 220, and the subsystem Sys_B(211) in FIG. 2, respectively, and each instance stores information dependent on the target system 300. In this example, connection relation between instances and instance names (IDs) in the target system correspond to the dependency information. The behavior scenarios Sys_A_model(320), Router_model(321), Sys_B_model(322) are information obtained by modeling the operations of the subsystem Sys_A(210), the network 220, and the subsystem Sys_B(211) respectively, and are associated with the instances 311, 312, 313 of the configuration model, respectively.

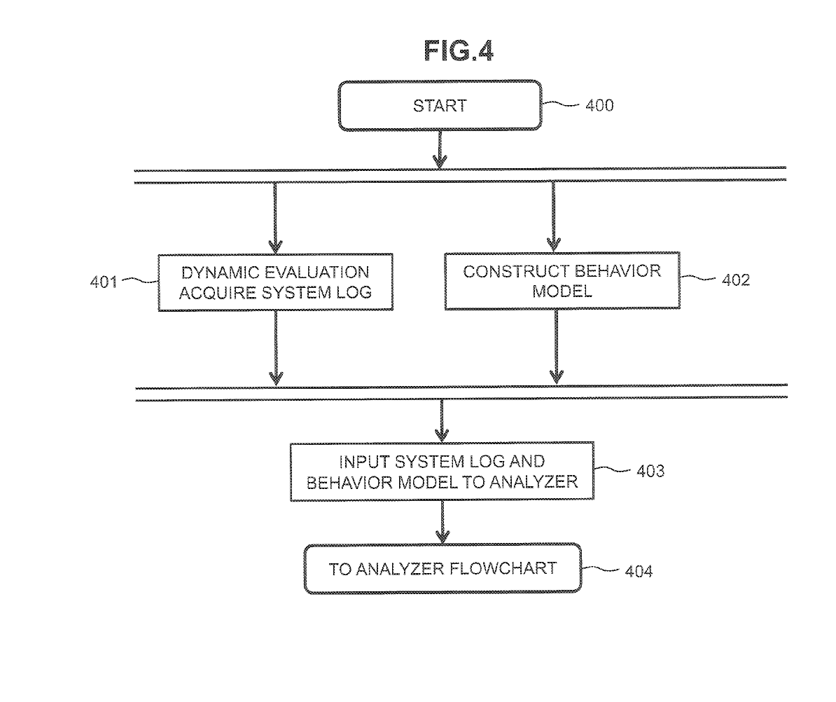

The flow of the whole analysis will be described. FIG. 4 is an explanation diagram showing the flow of the whole analysis. The analysis is started (start 400) by constructing the behavior model 111 as illustrated in FIG. 3 (402). Thereafter, or in parallel therewith, the dynamic evaluation of the target system 101 is performed, and the system log 104 is acquired (401). The behavior model 111 constructed beforehand and the acquired system log 104 are inputted to the analyzer 114 (403). The analysis device 110 performs the analysis in accordance with the later-described flow (404).

The operation of the analysis device 110 will be described. The analyzer 114 evaluates the system log 104 in accordance with the description of the behavior model 111 (e.g., 300 in FIG. 3), and automatically searches for how the target system 101 (e.g., 200 in FIG. 2) has operated during the dynamic evaluation. The system log 104 is acquired by dynamically evaluating the target system 101. The dynamic evaluation is performed by simulation or an actual machine. At this time, a system log in which times common to the whole target system 101 are recorded as time stamps is acquired from each subsystem. For example, by the technique described in the above-described Patent Literature 2, the desired system log 104 can be acquired.

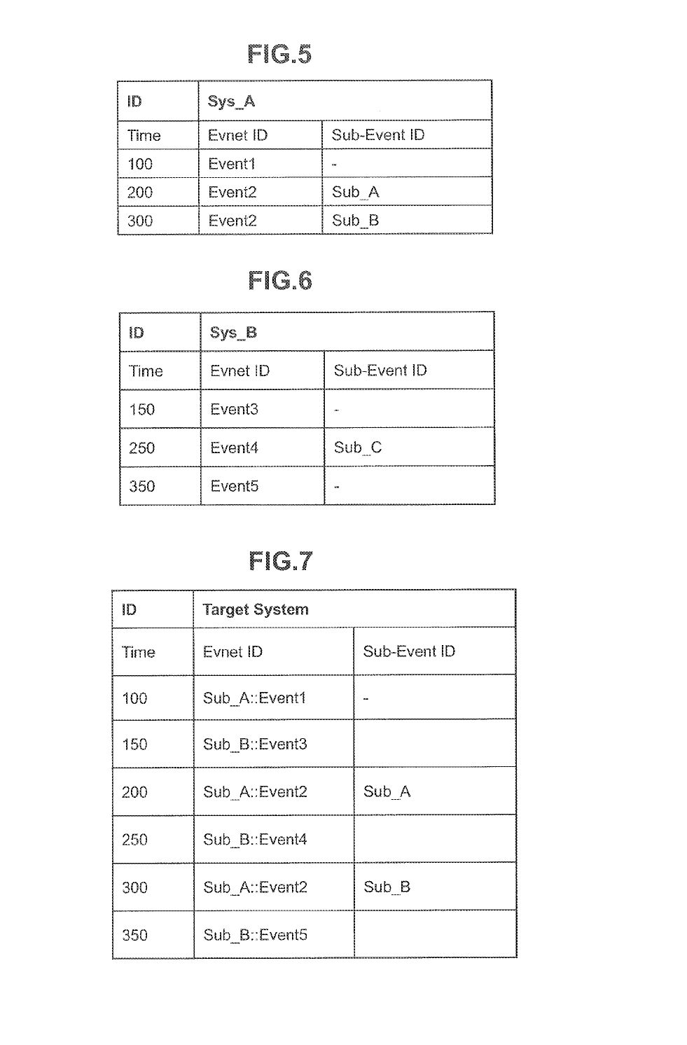

FIGS. 5, 6, and 7 show an example of the system log 104. As in the example shown in FIG. 2, the target system 200 as an example of the target system 101 is comprised of the two subsystems (Sys_A and Sys_B) 210 and 211, and each subsystem outputs a log individually. FIGS. 5 and 6 show examples of logs that the subsystems (Sys_A and Sys_B) 210 and 211 output respectively. An event occurrence time (Time), event identification information (Event ID), user-defined information (Sub-Event ID), and the like are recorded in the log. The dynamic evaluation device 100 rearranges logs based on event occurrence times, and constructs a temporally consistent system log 104. FIG. 7 shows an example of the system log 104 obtained by integrating the logs outputted individually from the subsystems. The dynamic evaluation device 100 may integrate the logs and input the integrated log to the analysis device 110. Alternatively, the logs outputted individually from the subsystems in the dynamic evaluation device 100 may be inputted to the analysis device 110 as they are, and the temporally consistent system log 104 may be generated as intermediate data in the analysis device 110.

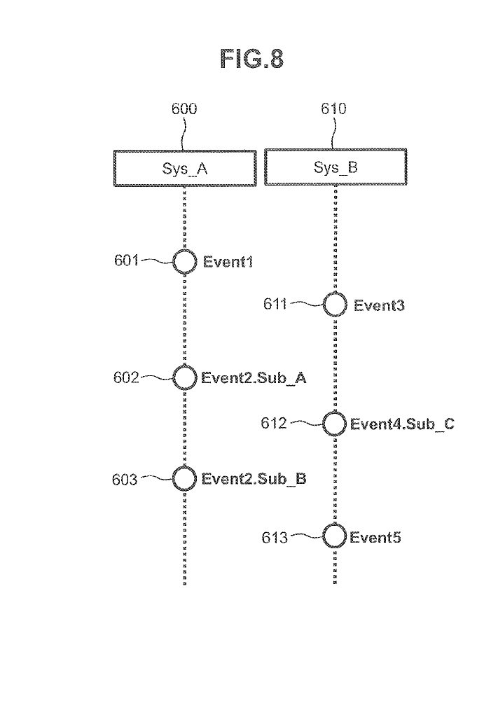

FIG. 8 is an explanation diagram schematically showing the integrated system log. The vertical axis indicates the time, which elapses downward. Following the above examples, lifelines 600, 610 denote the subsystems (Sys_A and Sys_B) 210 and 211 which output the logs, and circular symbols denote the occurrences of events 601 to 603 and 611 to 613. According to FIG. 5, it can be seen that three events Event1(601), Event2.Sub_A(602), Event2.Sub_A(603) have occurred at times 100, 200, 300 in the subsystem (Sys_A)210, respectively. Further, according to FIG. 6, it can be seen that three events Event3(611), Event4.Sub_C(612), Event5(613) have occurred at times 150, 250, 350 in the subsystem (Sys_B)211, respectively. In FIG. 8, on the lifeline 600 of the subsystem (Sys_A)210, Event1(601), Event2.Sub_A(602), Event2.Sub_A(603) are shown corresponding to the respective occurrence times. In the subsystem (Sys_B)211, the event Event3(611), which belongs to the lifeline 610, has occurred at Time 150 and is therefore shown at the time between the event Event1(601) at Time 100 and the event Event2.Sub_A(602) at Time 200. Similarly, the event Event4.Sub_C(612) at Time 250 also belongs to the lifeline 610, and is shown at the time between the event Event2.Sub_A(602) at Time 200 and the event Event2.Sub_A(603) at Time 300. Further, the event Event5(613) at Time 350 also belongs to the lifeline 610, and is shown at the time after the event Event2.Sub_A(603) at Time 300.

As described above, the time stamp outputted from each subsystem to the log is based on the time common to the whole target system 101; therefore, it is possible to accurately grasp the actually generated before-after relation between events generated from different subsystems as well. In this context, “the time common to the whole target system 101” does not need to be exactly the same time, but may include a certain tolerance. Two events generated by two tasks having a causal relation can be recorded in the log in reflection of actual occurrence order. For example, in the case where each subsystem is provided with a timer, recording can be performed within a range, as the tolerance of the timer, that enables the accurate determination of the occurrence order, not at the exact time of occurrence of the event. The occurrence order of a plurality of events generated substantially simultaneously by a plurality of tasks not having a causal relation does not necessarily need to be accurate. In consideration of the above conditions, the tolerance allowed for “the common time” can be defined as appropriate.

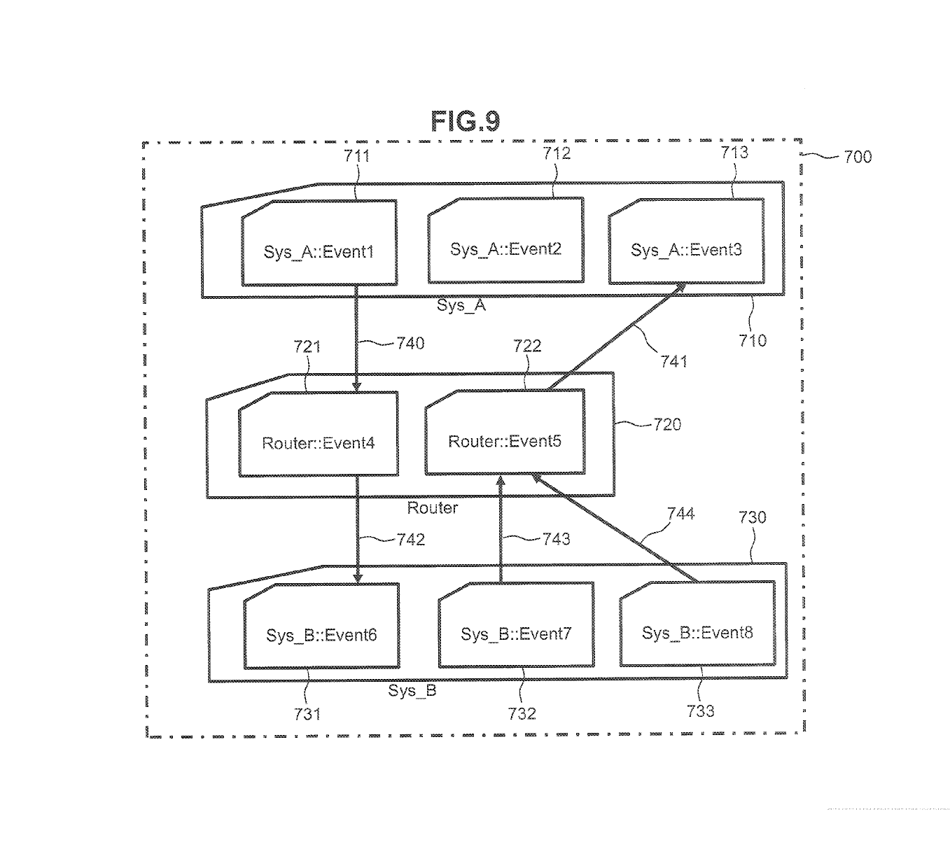

FIG. 9 shows an example of the association of tasks of the behavior scenarios 112 in the behavior model 111.

The behavior scenario is defined as the set of tasks describing the function of the subsystem or the network. A description will be made taking as an example the target system 200 comprised of the two subsystems (Sys_A and Sys_B) 210 and 211 and the network 220, following the foregoing description. The behavior model 111 illustrated in FIG. 9 includes a structure model 700, behavior scenarios (Sys_A and Sys_B) 710 and 730 corresponding to the subsystems (Sys_A and Sys_B) 210 and 211 respectively, and a behavior scenario (Router) 720 corresponding to the network 220. The behavior scenario 710 is comprised of tasks 711, 712, 713, which generate events Event1, Event1, Event3, respectively. The event is written as “subsystem name::event name”. “Sys_A::Event1” signifies Event1 of Sys_A. Similarly, the behavior scenario 720 corresponding to the network 220 is comprised of tasks 721, 722, which generate events Event4, Event5, respectively, and the behavior scenario 730 corresponding to the subsystem (Sys_B)211 is comprised of tasks 731, 732, 733, which generate events Event6, Event1, Event8, respectively.

The analyzer 114 reads the configuration model, and associates tasks of the behavior scenarios. In the example, the tasks 711, 721, 731 are associated. The result of the association is indicated by connections 740, 742. This means that one of the application functions of the target system starts with the task 711, goes through the task 721, and ends with the task 731. When this function is executed, Sys_A::Event1, Router::Event4, Sys_B::Event6 occur sequentially. Further, the tasks 732, 733, 722, 713 are associated. The result of the association is indicated by connections 743, 744, 741. This means that one of the application functions of the target system starts with the task 732, goes through the task 722, and ends with the task 713, and another function starts with the task 733, goes through the same task 722, and ends with the same task 713. When the application (function) with the task 732 as the start task is executed, Sys_B::Event7, Router::Event5, Sys_A::Event3 occur sequentially, and when the application (function) with the task 733 as the start task is executed, Sys_B::Event8, Router::Event5, Sys_A::Event3 occur sequentially.

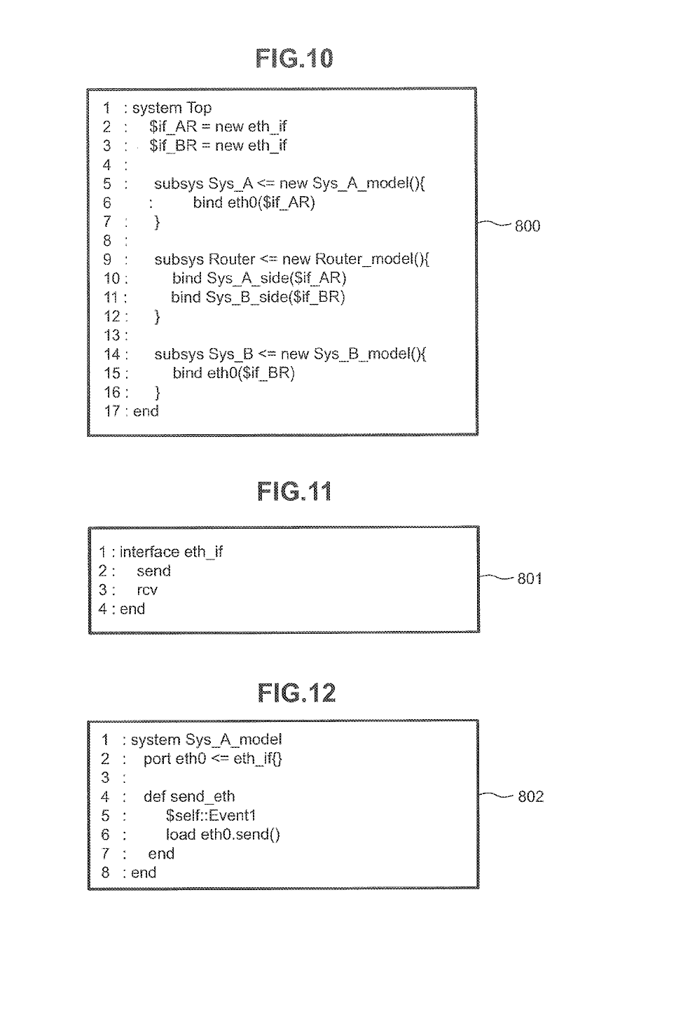

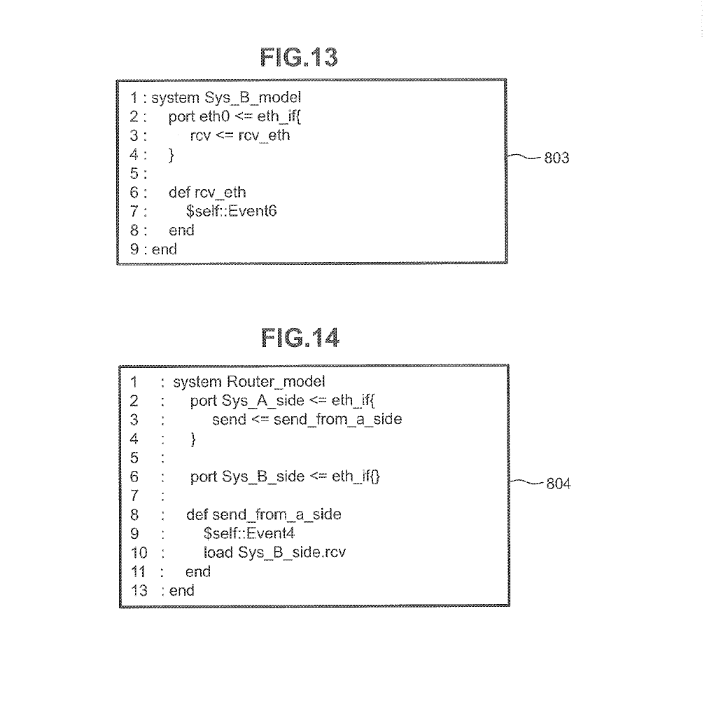

The association of tasks by analyzing the behavior model will be described in more detail. FIGS. 10 to 14 show, by source code, examples of various kinds of data configuring the behavior model 111. Attention is focused on code describing the model of the application defined over the tasks 711, 721, and 731, and the other code is not shown in the figures. Code 800 shown in FIG. 10 denotes the structure model 700, code 801 shown in FIG. 11 denotes an interface declaration, code 802 shown in FIG. 12 denotes the behavior scenario 710(Sys_A), code 803 shown in FIG. 13 denotes the behavior scenario 730(Sys_B), and code 804 shown in FIG. 14 denotes the behavior scenario 720(Router).

In the code 800 of the structure model (FIG. 10), the instance generation of the model and the definition of the connection relation are performed. For the instance generation, in the 5th line of the code 800, an instance name (Sys_A) is defined by a subsystem statement, and the type (Sys_A_model) of instance to be newly generated is specified by a new statement. Similarly, the instance of Router is generated in the 9th line, and the instance of Sys_B is generated in the 14th line. The connection relation between models is defined using an interface class. Taking the connection 740 as an example, first, an instance $if_AR of the interface class is created in the 2nd line, and registered in Sys_A and Router by bind statements in the 6th and 10th lines. In this case, eth_if in the 2nd line denotes an interface class name, and eth0 in the 6th line and Sys_A_side in the 10th line denote port names. Similarly, the connection 742 is defined in the 3rd, 11th, and 15th lines.

The interface class mediates the operation between models. In the interface declaration shown by the code 801 in FIG. 11, the interface of the class name eth_if is declared in the 1st line, and it is described in the 2nd to 3rd lines that the defined class has the task reference of send, rcv.

Next, the description of the behavior scenario will be described. The behavior scenario is comprised of a task declaration and a port declaration. In the behavior scenario 802 of Sys_A shown in FIG. 12, the 2nd line represents a port declaration, and the 4th to 7th lines represent a task declaration. Similarly, in the behavior scenario 803 of Sys_B shown in FIG. 13, the 2nd to 4th lines represent a port declaration, and the 6th to 8th lines represent a task declaration; and in the behavior scenario 804 of Router shown in FIG. 14, the 2nd to 4th lines and the 6th line represent port declarations, and the 8th to 11th lines represent a task declaration.

In the task declaration, the order of an event to be analyzed and a task to be executed next are defined. Taking send_eth of the code 802 as an example, $self::Event1 in the 5th line denotes an event to be analyzed (FIG. 12). $self is a reserved variable representing the instance name (Sys_A in this example). Further, a load statement in the 6th line invokes a task to be analyzed next.

The port declaration defines a task released outside the model. When the instance of the interface is passed in the bind statement from an upper model, the port performs association with the instance and registration to the task reference. For example, the interface instance $if_AR is associated with the port eth0 of Sys_A in the bind statement in the 6th line of the code 800, and in the bind statement in the 10th line, the interface instance $if_AR is associated with Sys_A_side, and a send_from_a_side task is registered to the task reference send (FIG. 10).

By using the port and the interface, even if a connection counterpart is undefined, the task can invoke the task defined outside the model by the same code. Taking the 6th line of the code 802 (FIG. 12) as an example, the analyzer 114 reads eth0.send in the load statement. Since the first element “eth0” is a port, the analyzer 114 refers to the interface instance $if_AR associated with the port “eth0”. The analyzer 114 reads the next element “send”, and invokes the task registered to the task reference send of $if_AR. In this example, send_from_a_side in the code 804 (FIG. 14) is registered, and invoked. Thereby, the send_eth task of Sys_A_model can invoke the task of send_from_a_side of Router_model. This correspond to the processing of the connection 740. Similarly, by processing the connection of $if_BR, the connection 742 can be implemented. Lastly, when a user specifies a start task (send_eth of Sys_A in this example), the processing is performed in the order of the task 711, the task 721, and the task 731.

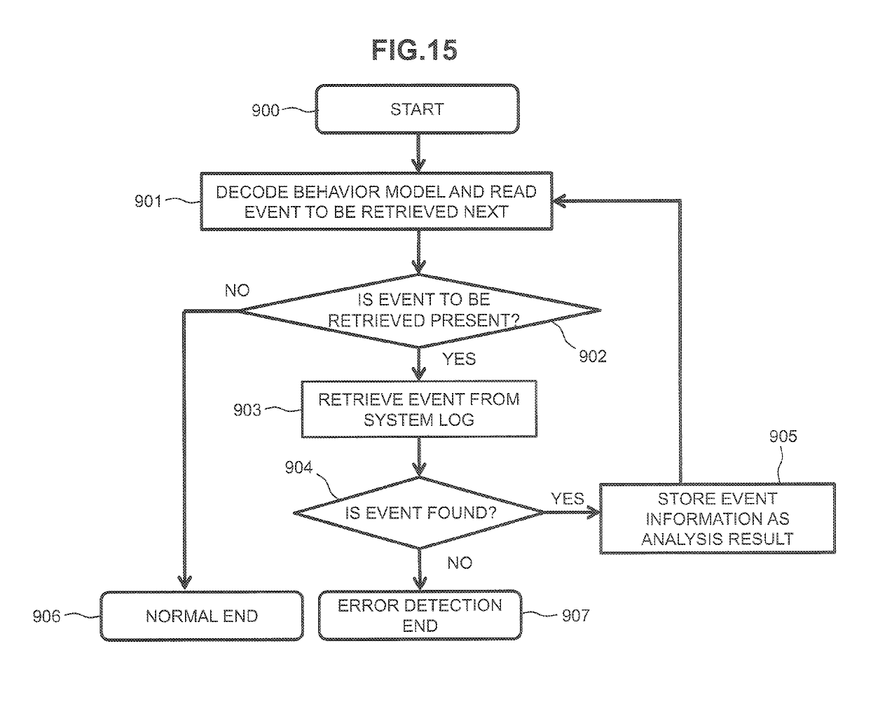

An analysis flow by the analyzer 114 will be described. FIG. 15 is a flowchart showing an example of a flow in which the analyzer 114 searches the system log 104. The analyzer 114 decodes the behavior model 111 and reads an event to be retrieved next (step 901). Then, the presence or absence of an event to be retrieved is determined (step 902), and if the event to be retrieved is absent, the flow ends normally (step 906). If the event to be retrieved is present, the event of the retrieval target is retrieved from the system log 104 (step 903). At this time, if the event of the retrieval target is the first event generated by the start task, the retrieval is performed from the top of the system log 104, and if there is an event found by the preceding retrieval, the retrieval is performed after the occurrence time of the event. It is determined whether or not the event of the retrieval target is found (step 904). If the event is found, the found event information is stored as an analysis result 115 (step 905), the flow returns to reading an event to be retrieved next (step 901). If the event is not found, the flow ends with error detection (step 907). By repeating the retrieval of the event (step 903), the event log 104 is compared with the behavior model 111, thus making it possible to select a behavior that best matches the operation recorded in the event log 104.

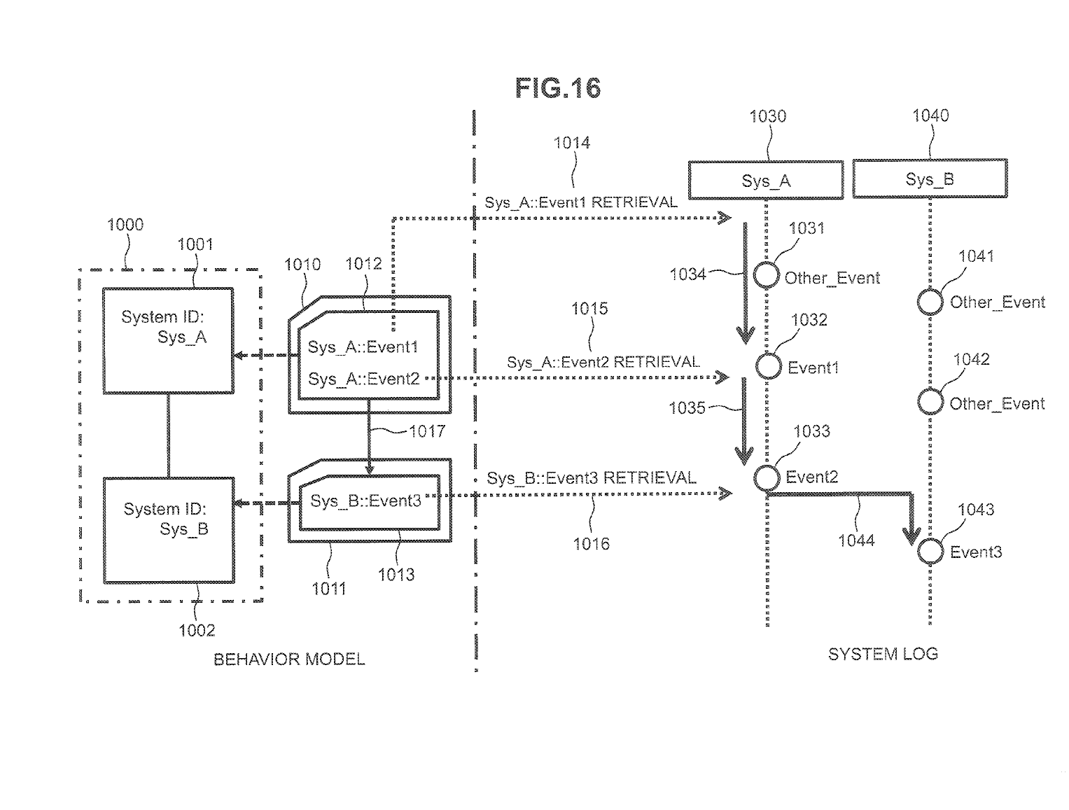

FIG. 16 shows a specific example. The behavior model 111 as illustrated in FIG. 3 and the system log 104 as illustrated in FIG. 8 are shown side by side. The behavior model 111 is comprised of a structure model 1000 and behavior scenarios 1010, 1011. In the operation example in FIG. 16, from the configuration model 1000, the analyzer 114 associates a task 1012 with a task 1013, with the task 1012 as a start task. The system log 104 includes lifelines 1030 and 1040, and there are shown events 1031 to 1033 belonging to the lifeline 1030 and events 1041 to 1043 belonging to the lifeline 1040. The behavior scenario 1010 and the lifeline 1030 correspond to the subsystem (Sys_A)210, and events Sys_A::Event1 and Sys_A::Event2 generated by the task 1012 correspond to the events 1032 and 1033 on the lifeline 1030, respectively. The behavior scenario 1011 and the lifeline 1040 correspond to the subsystem (Sys_B)211, and an event Sys_B::Event3 generated by the task 1013 corresponds to the event 1043 on the lifeline 1040. The events 1031, 1041, 1042 are other events (Other_Event) whose corresponding tasks are not shown in the figure.

The analyzer 114 reads the first retrieval event Sys_A::Event1 from the start task 1012, and performs Sys_A::Event1 retrieval 1014 from the system log 104. Since Sys_A::Event1 is the first event generated by the start task 1012 of the subsystem (Sys_A)210, retrieval 1034 of Event1 is performed from the top of the lifeline 1030 which is the log of Sys_A. If the corresponding event 1032 is found, event information (time and user-defined information) is stored as the analysis result 115. After the end of the first retrieval 1014, 1034, the analyzer 114 reads the next retrieval event Sys_A::Event2 from the behavior scenario 1010, and performs retrieval 1015 of Sys_A::Event2. For the Sys_A::Event2 retrieval 1015, the start time of the retrieval is set to be immediately after the time of Sys_A::Event1 (event 1032) found by the immediately preceding retrieval 1014, 1034, thereby performing retrieval 1035. If Sys_A::Event2 (event 1033) is found, the analyzer 114 further reads the next retrieval event. In the reading of the next event, since the behavior task 1012 has been read to the end, Sys_B::Event3 of the task 1013 is read from the behavior scenario 1011 in accordance with a relation 1017. In the retrieval of Sys_B::Event3 retrieval 1016, retrieval 1044 of Event3 is performed from the lifeline 1040 which is the log of Sys_B, with the occurrence time of Sys_A::Event2 (event 1033) as a starting point. By the retrieval, the analyzer finds Sys_B::Event3 (event 1043). The analyzer 114 finishes reading all events including in the task 1013 from the behavior scenario 1011, and, due to no next relation, stores the analysis result and finishes the evaluation. If there is an event not found by a series of analyses, an error is recorded in the analysis result 115. Based on the analysis result 115, the user can analyze the operation situation of the target system 101, such as the evaluation of real-time performance (operation time) and the evaluation of a generated event (an event to be generated is not generated).

In the case of analyzing an application operating periodically, the above processing is repeated to analyze the whole system log 104. For example, in the case of analyzing an application repeatedly generating Sys_A::Event1, Sys_A::Event2, Sys_B::Event3; after the retrieval 1014, 1034 of Sys_A::Event1, the retrieval 1015, 1035 of Sys_A::Event2, and the retrieval 1016, 1044 of Sys_B::Event3 are performed, the same retrieval is repeated after the subsequent time. In the case where the target system 101 is configured to allow the starting of the next repetition without waiting for the completion of the occurrence of a series of events Sys_A::Event1, Sys_A::Event2, Sys_B::Event3, the start time of the repetitive retrieval in the system log 104 is immediately after the leading event Sys_A::Event1 instead of the last event Sys_B::Event3.

As described above, the behavior model 111 is introduced for the analysis of the system log 104 to analyze the operation of the target system 101. The behavior model 111 is described by combining the model (behavior scenario 112) representing the operation of the subsystem 102 and the model (configuration model 113) representing the configuration of the target system 111. By introducing the behavior model 111, it is possible to automatically search for the operation of the application only by specifying the start task. Further, by separating the model of the operation (behavior scenario 112) from the model of the configuration (configuration model 113), it is possible to reuse the model of the operation part. By collecting a part changed according to the target system in the configuration model 113, the behavior scenario 112 does not need to be changed for each target system 111.

### Second Embodiment

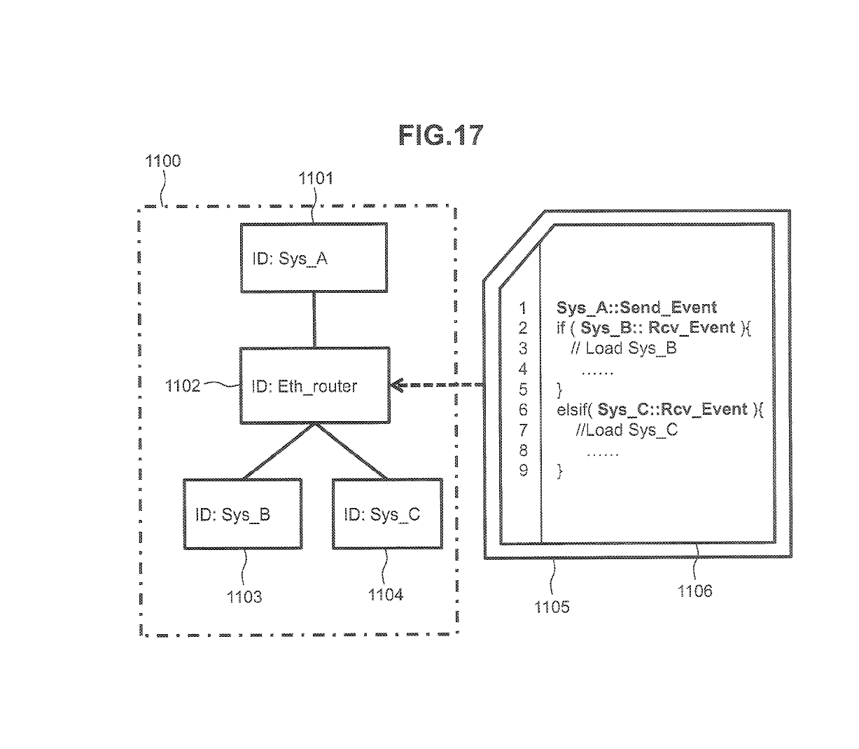

In a second embodiment, an example for estimating the operation of the target system 101 from the system log 104 will be described. For example, assume that three subsystems communicate with each other. FIG. 17 illustrates a behavior model of the target system 101 in which instances Sys_A(1101), Sys_B(1103), Sys_C(1104) of the subsystems communicate with each other through an instance Eth_router(1102) obtained by modeling a router in a configuration model 1100. Reference numeral 1105 denotes a behavior scenario of the router, and reference numeral 1106 denotes a task included in the behavior scenario 1105.

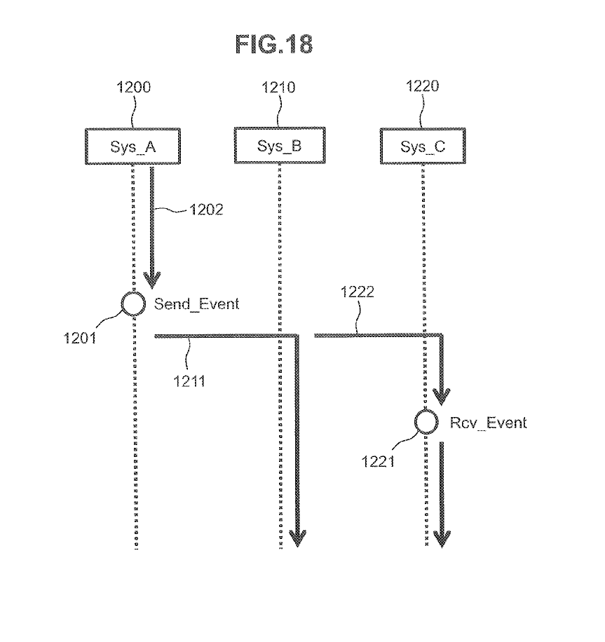

FIG. 18 shows an example of the system log 104 acquired from the target system 101 of an operation estimation target. There are shown lifelines 1200, 1210, 1220 corresponding to the subsystems Sys_A, Sys_B, Sys_C respectively, an event 1201 is shown on the lifeline 1200, and an event 1221 is shown on the lifeline 1220. This represents an operation in which Sys_A(1200) performs a packet transmission (event 1201) and Sys_C(1220) performs a packet reception (event 1221).

An example of estimating the operation is shown in the behavior scenario 1105. The task 1106 analyzes whether the transmitted packet can be received at the opposite side. The analyzer 114 reads the 1st line of the task 1106, and retrieves a packet transmission event (Sys_A::Send_Event) of Sys_A(1200) from the system log 104. This processing corresponds to retrieval 1202 in FIG. 18, which finds the event 1201. Then, the analyzer 114 evaluates the condition of an if statement in the 2nd line of the task 1106, and retrieves a packet reception event (Sys_B::Rcv_Event) of Sys_B(1210). This corresponds to retrieval 1211, and the reception event does not exist on Sys_B(1210); therefore, the retrieval fails. Due to the failure of the condition expression in the 2nd line, the analyzer 114 reads the condition expression of an elsif statement in the 6th line, and retrieves a reception event (Sys_C::Rcv_Event) of Sys_C(1220). Since the packet reception event is recorded on Sys_C(1220), the analyzer 114 finds the event 1221 by retrieval 1222, and reads the task in the 7th and subsequent lines. By a series of evaluations, the analyzer 114 has detected the packet reception event on Sys_C(1220) but not on Sys_B(1210), and therefore determines that the packet transmitted from Sys_A(1101) has been routed to Sys_C(1104) by Eth_router(1102). Thereby, the analyzer 114 can estimate the operation without considering the internal state of Eth_router(1102).

In the dynamic evaluation by simulation, when the packet is sent from Sys_A(1101) to Sys_B(1103) or Sys_C(1104), Eth_router(1102) compares the IP address of the packet with a routing table in Eth_router(1102), and determines whether to forward the packet to Sys_B(1103) or Sys_C(1104). A series of operations change depending on the setting of the internal state of Eth_router(1102), so that deviation from an actual machine operation might occur depending on condition setting at the time of simulation. On the other hand, in the analysis according to the second embodiment, the analyzer 114 does not refer to the internal state of Eth_router(1102) but uses the system log 104 for evaluation. This makes it possible to evaluate a behavior not deviating from the actual operation. The utilization of this feature enables application where if the actual machine causes an error operation, an error condition is extracted and fed back to the simulation.

### Third Embodiment

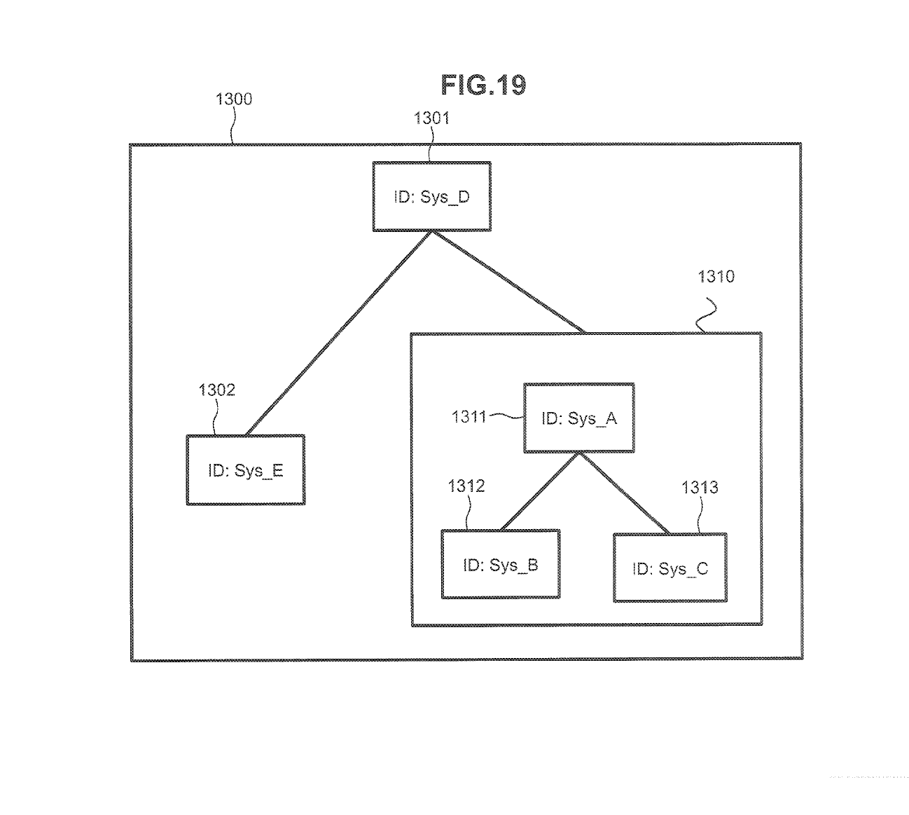

It is also possible to analyze a larger target system by utilizing the behavior model. FIG. 19 shows an example thereof. A behavior model 1300 includes a behavior model 1310 as a partial model. This means that the behavior model 1300 is constructed by adding Sys_D(1301), Sys_E(1302) of subsystems to a system (behavior model 1310) comprised of instances Sys_A(1311), Sys_B(1312), Sys_C(1313) of subsystems.

In a complex system as in FIG. 19, it is common to divide the system into several functions, perform unit verification for each function, and then verify the whole system. In this embodiment, the operation of the system is managed with electronic data as the behavior model, which enables the diversion of the model. The behavior model 1310 is created by unit verification, and then the behavior model 1310 subjected to unit verification is diverted in the verification of the whole system, so that the behavior model 1300 can be constructed. Thus, a result object can be stored as data, which facilitates the diversion and expansion of design assets.

### Fifth Embodiment

It is also possible to construct the target system by horizontal specialization.

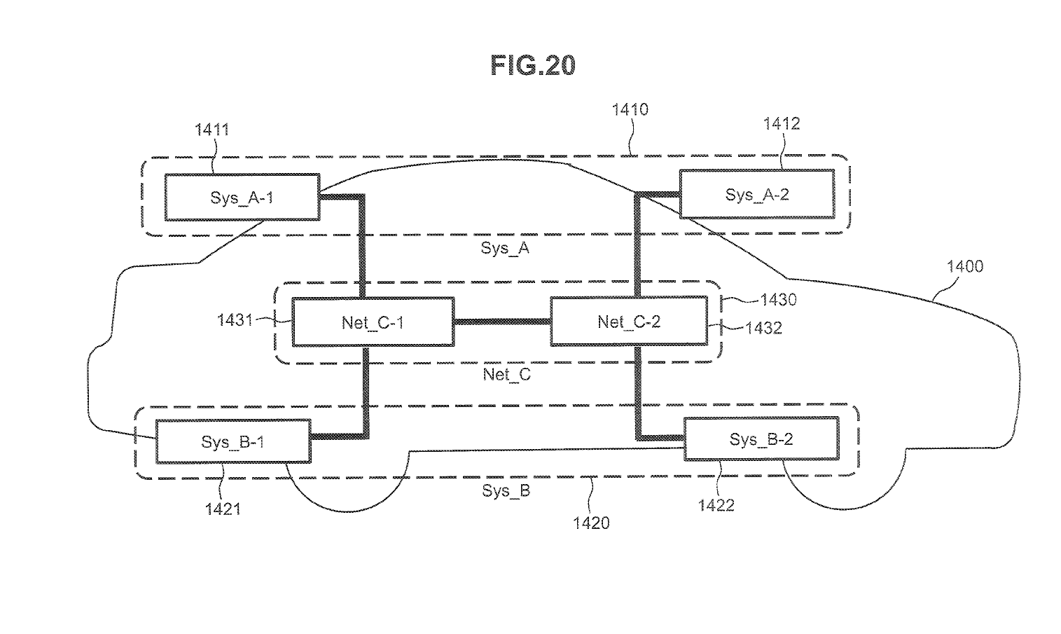

FIG. 20 is a schematic block diagram showing a configuration example of a target system in which a plurality of control units are connected to an in-vehicle network. The target system 1400 is configured by mutually connecting a subsystem Sys_A(1410) and a subsystem Sys_B(1420) through a network Net_C(1430). The subsystem Sys_A(1410) includes subordinate subsystems Sys_A−1(1411) and Sys_A−2(1412), the subsystem Sys_B(1420) includes subordinate subsystems Sys_B−1(1421) and Sys_B−2(1422), and the network Net_C(1430) includes subordinate networks Net_C−1(1431) and Net_C−2(1432). The subsystems Sys_A−1(1411), Sys_A−2(1412), Sys_B−1(1421), and Sys_B−2(1422) are each, e.g., a control unit (ECU: Electronic Control Unit), and the network Net_C(1430) is, for example, an in-vehicle network (CAN: Controller Area Network).

A case where the subsystem Sys_A(1410) and the subsystem Sys_B(1420) are introduced from mutually different vendors will be described as an example of horizontal specialization.

Sys_A−1(1411) and Sys_A−2(1412) in the subsystem Sys_A(1410) and Sys_B−1(1421) and Sys_B−2(1422) in the subsystem Sys_B(1420) communicate with each other through the network Net_C(1430). At this time, the subsystem Sys_A(1410) and the subsystem Sys_B(1420) use the network Net_C(1430) in common, and therefore affect each other. Accordingly, to confirm that the subsystem Sys_A(1410) and the subsystem Sys_B(1420) operate normally in the target system 1400, it is necessary to perform evaluation in a state where the subsystem Sys_A(1410), the subsystem Sys_B(1420), and the network Net_C(1430) are all present.

In the past, to evaluate the operation of the subsystem on the target system, a person has to perform visual check by inserting or connecting an observation instrument to a particular point. In the insertion of the observation instrument, the number of insertions and an observation range are limited. Further, verification is usually performed by visual determination, which disadvantageously causes observation limitation and man-hours.

On the other hand, in this embodiment, the behavior models of the subsystem Sys_A(1410) and the subsystem Sys_B(1420) are released from the respective vendors, and introduced into the behavior model of the target system 1400, thereby making it possible to automatically evaluate the operation of each subsystem. By utilizing the behavior models, it is possible to evaluate, on the target system, items that are difficult to evaluate for other than the developers of the subsystems. Thereby, it becomes possible to evaluate a plurality of applications operating on the target system, which is difficult in the past.

While the invention made above by the present inventors has been described specifically based on the illustrated embodiments, the present invention is not limited thereto. It is needless to say that various changes and modifications can be made thereto without departing from the spirit and scope of the invention.

For example, the number of subsystems and the depth of a hierarchy configuring subsystems are arbitrary, a function such as a network, a relay router, and a gateway for connecting between subsystems is positioned as another subsystem, and a behavior scenario is defined, thus configuring a behavior model.

### INDUSTRIAL APPLICABILITY

The present invention relates to an analysis device and an analysis method, and particularly can be widely applied to an analysis device and an analysis method for supporting the operation analysis of a system comprised of a plurality of subsystems.

### EXPLANATION OF REFERENCE NUMERALS

100: Dynamic Evaluation Device
101, 200, 1400: Target System
102, 210, 211, 1410 to 1412, 1420 to 1422, 1430 to 1432: Subsystem
103, 220: Network
104: System Log
110: Analysis Device
111, 300, 1300, 1310: Behavior Model
112, 320 to 322, 710, 720, 730, 1010, 1011, 1105: Behavior Scenario
113, 310, 700, 1000, 1100: Configuration Model
311 to 313, 1001, 1002, 1101 to 1104, 1301, 1302, 1311 to 1313: Instance (Instance of Behavior Scenario in Configuration Model)
114: Analyzer
115: Analysis Result
400 to 404: Each Step of Analysis
600, 610, 1030, 1040, 1200, 1210, 1220: Lifeline
601 to 603, 611 to 613, 1031 to 1033, 1041 to 1043, 1201, 1221: Event
711 to 713, 721 to 722, 731 to 733, 1012, 1013, 1106: Task
740 to 744, 1017: Connection, Relation between Tasks
800 to 804: Source Code Configuring Behavior Model
900 to 907: Each Step of Analysis Flow by Analyzer
1014 to 1016, 1034, 1035, 1044, 1202, 1211, 1222: Event Retrieval

What is claimed is:

1. An analysis device for analyzing an operation of a target system comprised of a plurality of subsystems, the analysis device comprising:
a behavior model; and
an analyzer,
wherein the behavior model includes a plurality of behavior scenarios representing respective behaviors of the subsystems and a configuration model representing connection relation between the subsystems,
wherein in each behavior scenario, a task executed by a corresponding subsystem and an event generated by the task are described,
wherein a system log in which an event generated from each subsystem when the target system is operated and a time stamp indicating an occurrence time of the event by a time common to the whole target system are recorded is inputted to the analyzer,
wherein the analyzer extracts, from the behavior model, a plurality of tasks executed sequentially with a predetermined start task as a starting point and a string of a plurality of events sequentially occurring accordingly, and
wherein the analyzer collates a plurality of events arranged in occurrence order based on the time stamp recorded in the system log with the string of the events extracted from the behavior model.

2. The analysis device according to claim 1, wherein the analyzer extracts a plurality of start tasks and a plurality of corresponding event strings comprised of a plurality of events, and searches for whether or not the events arranged in the same order exist in the same order in the events recorded in the system log, for each event string.

3. The analysis device according to claim 2, wherein if an event of a search target is not found as a result of the search, the analyzer outputs or records an error as the search result.

4. The analysis device according to claim 2, wherein after the analyzer finds the last event included in an event string by search of the system log, the analyzer searches for whether or not the first event corresponding to a start task of the event string exists again at a time after the first event of the system log, and again searches the event string if the event exists.

5. The analysis device according to claim 1,
wherein in the target system, in at least a part of the subsystems, a network for relaying communication between a plurality of subsystems is included, and a behavior scenario corresponding to the network is included in the behavior model, and
wherein a description for associating a subsystem and an event on a transmission side with a subsystem and an event on a reception side is included in the behavior scenario corresponding to the network.

6. The analysis device according to claim 5, wherein if a plurality of subsystems and events on the reception side are associated with one event on the transmission side in the behavior scenario corresponding to the network, the analyzer extracts event strings including branches to all associated events from the behavior model, and searches for which branch exists in the system log.

7. The analysis device according to claim 1, wherein the target system includes a plurality of control modules interconnected through a network, as the subsystems, and the system log is acquired by an actual operation of the target system.

8. The analysis device according to claim 1, wherein the target system includes a plurality of control modules interconnected through a network, as the subsystems, and the system log is acquired by a simulation of the target system.

9. An analysis method for analyzing an operation of a target system comprised of a plurality of subsystems, using a computer, the analysis method having a behavior model stored in a storage device of the computer and an analysis program for performing an analysis operation by being executed by the computer,
wherein the behavior model includes a plurality of behavior scenarios representing respective behaviors of the subsystems and a configuration model representing connection relation between the subsystems,
wherein in each behavior scenario, a task executed by a corresponding subsystem and an event generated by the task are described, and
wherein a system log in which an event generated from each subsystem when the target system is operated and a time stamp indicating an occurrence time of the event by a time common to the whole target system are recorded is inputted to the analysis operation,
the analysis operation comprising:
a first step of extracting, from the behavior model, a plurality of tasks executed sequentially with a predetermined start task as a starting point and a string of a plurality of events sequentially occurring accordingly; and
a second step of collating a plurality of events arranged in occurrence order based on the time stamp recorded in the system log with the string of the events extracted from the behavior model.

10. The analysis method according to claim 9,
wherein the first step extracts a plurality of start tasks and a plurality of corresponding event strings comprised of a plurality of events, and
wherein the second step searches for whether or not the events arranged in the same order exist in the same order in the events recorded in the system log, for each event string.

11. The analysis method according to claim 10, wherein if an event of a search target is not found as a result of the search, the second step outputs or records an error as the search result.

12. The analysis method according to claim 10, wherein after the second step finds the last event included in an event string by search of the system log, the second step searches for whether or not the first event corresponding to a start task of the event string exists again at a time after the first event of the system log, and again searches the event string if the event exists.

13. The analysis method according to claim 9,
wherein in the target system, in at least a part of the subsystems, a network for relaying communication between a plurality of subsystems is included, and a behavior scenario corresponding to the network is included in the behavior model, and
wherein a description for associating a subsystem and an event on a transmission side with a subsystem and an event on a reception side is included in the behavior scenario corresponding to the network.

14. The analysis method according to claim 13, wherein if a plurality of subsystems and events on the reception side are associated with one event on the transmission side in the behavior scenario corresponding to the network,
the first step extracts event strings including branches to all associated events from the behavior model, and
the second step searches for which branch exists in the system log.

15. The analysis method according to claim 9, wherein the target system includes a plurality of control modules interconnected through a network, as the subsystems, and the system log is acquired by an actual operation of the target system.

16. The analysis method according to claim 9, wherein the target system includes a plurality of control modules interconnected through a network, as the subsystems, and the system log is acquired by a simulation of the target system.

17. An analysis device comprising a behavior model obtained by modeling an operation of a target system,
wherein a log in which an event occurring when the target system is operated is recorded in time series is inputted to the analysis device, and the analysis device searches for an event string according to occurrence order obtained by statically analyzing the behavior model, from a plurality of events recorded in the log in time series.

18. The analysis device according to claim 17,
wherein the target system includes a plurality of subsystems,
wherein the behavior model includes a plurality of behavior scenarios representing respective behaviors of the subsystems and a configuration model representing connection relation between the subsystems, and in each behavior scenario, a task executed by a corresponding subsystem and an event generated by the task are described,
wherein an event generated from each subsystem when the target system is operated and a time stamp indicating an occurrence time of the event by a time common to the whole target system are recorded in the log, and
wherein the analysis device extracts, from the behavior model, a plurality of tasks executed sequentially with a predetermined start task as a starting point and a string of a plurality of events sequentially occurring accordingly, and collates the string of the events with a plurality of events arranged in occurrence order based on the time stamp recorded in the log.
